(19) United States
(12) Patent Application Publication
(10) Pub. No.: US 2024/0059836 A1
(43) Pub. Date: Feb. 22, 2024

(54) POLYPHENYLENE ETHER BISMALEIMIDE RESIN

(71) Applicant: NAN YA PLASTICS CORPORATION, Taipei (TW)

(72) Inventors: Te-Chao Liao, TAIPEI (TW); Wen-Hua Lu, TAIPEI (TW); Chi-Lin Chen, TAIPEI (TW)

(73) Assignee: NAN YA PLASTICS CORPORATION, TAIPEI (TW)

(21) Appl. No.: 17/901,869

(22) Filed: Sep. 2, 2022

(30) Foreign Application Priority Data
Aug. 8, 2022 (TW) 111129785

(51) Int. Cl. C08G 65/48; C08G 65/26; C08G 65/332; C08F 222/06

(52) U.S. Cl. CPC C08G 65/485; C08G 65/2633; C08G 65/2612; C08G 65/2675; C08G 65/3324; C08F 222/06; C08G 2650/04

(57) ABSTRACT

A polyphenylene ether bismaleimide resin is provided. The polyphenylene ether bismaleimide resin (PPE-BMI) is formed from a modified polyphenylene ether diamine and a maleic anhydride by a condensation polymerization. The modified polyphenylene ether diamine is formed by reacting a phenol-based compound with a polyphenylene ether.

### CROSS-REFERENCE TO RELATED APPLICATION

This application claims the priority benefit of Taiwan application serial no. 111129785, filed on Aug. 8, 2022. The entirety of the above-mentioned patent application is hereby incorporated by reference herein and made a part of this specification.

### BACKGROUND

### Technical Field

The invention relates to a bismaleimide resin, particularly to a polyphenylene ether bismaleimide (PPE-BMI) resin.

### Description of Related Art

Polyphenylene ether resins have good insulation, acid and alkali resistance, dielectric constant (Dk) and dissipation factor (Df) and other characteristics, so it is usually applied in insulating materials of high-frequency printed circuit boards and other electronic substrates. However, the currently used polyphenylene ether resin has a problem of insufficient stability, which in turn has the disadvantage of poor processability.

### SUMMARY

The invention provides a polyphenylene ether bismaleimide resin capable of providing good dielectric properties and heat resistance.

A polyphenylene ether bismaleimide resin is formed from a modified polyphenylene ether diamine and a maleic anhydride by a condensation polymerization. The modified polyphenylene ether diamine is formed by reacting a phenol-based compound with a polyphenylene ether.

In an embodiment of the invention, a ratio of a mole number of the modified polyphenylene ether diamine to a mole number of the maleic anhydride is 1:1.1 to 1:1.6.

In an embodiment of the invention, a ratio of a mole number of the phenol-based compound to a mole number of the polyphenylene ether is 1:1 to 10:1.

In an embodiment of the invention, a weight average molecular weight of the polyphenylene ether bismaleimide resin is 1,000 to 8,000.

In an embodiment of the invention, the phenol-based compound includes two or more phenolic groups.

In an embodiment of the invention, the phenol-based compound includes any one of compounds represented by Formula (1) to Formula (9) as follows:

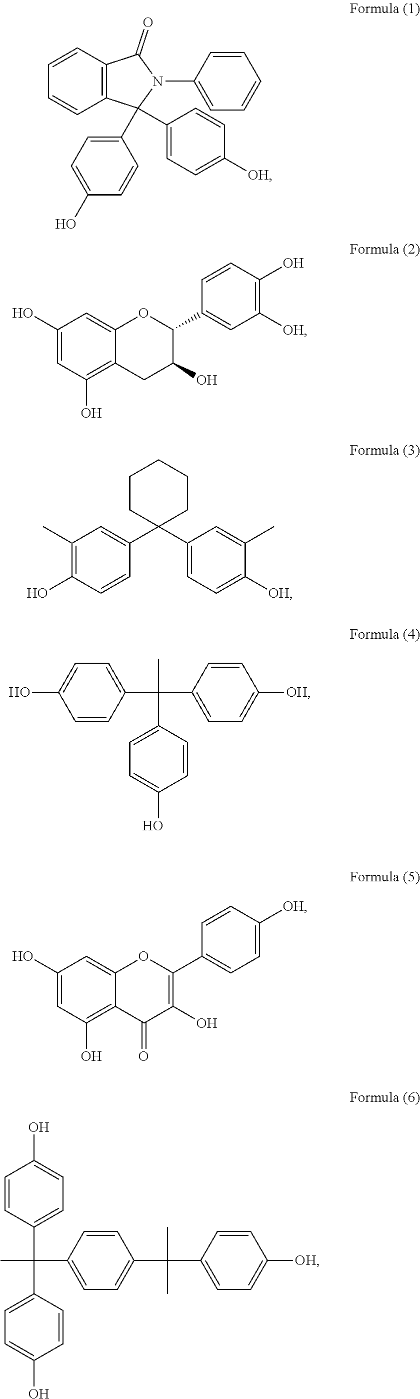 [SMILES: O=C1c2ccccc2C(c2ccc(O)cc2)(c2ccc(O)cc2)N1c1ccccc1 ; Oc1cc(O)c2c(c1)O[C@H](c1ccc(O)c(O)c1)[C@@H](O)C2 ; Cc1cc(C2(c3ccc(O)c(C)c3)CCCCC2)ccc1O ; CC(c1ccc(O)cc1)(c1ccc(O)cc1)c1ccc(O)cc1 ; O=c1c(O)c(-c2ccc(O)cc2)oc2cc(O)cc(O)c12 ; CC(C)(c1ccc(O)cc1)c1ccc(C(C)(c2ccc(O)cc2)c2ccc(O)cc2)cc1]

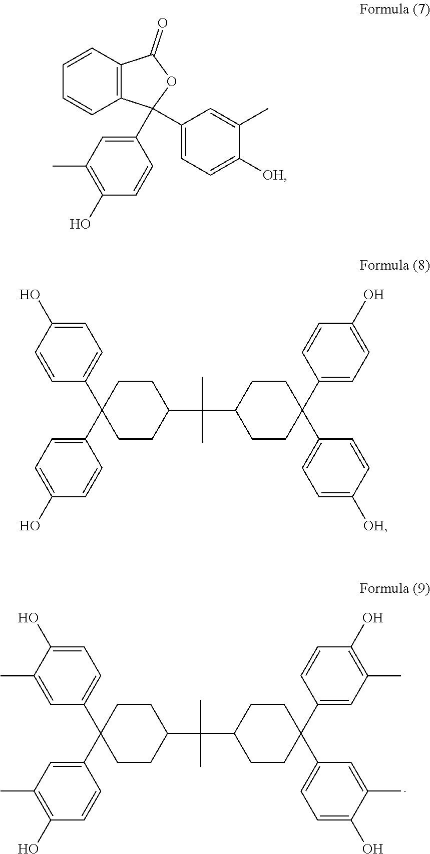

A polyphenylene ether bismaleimide resin has a structure represented by Formula (A) as follows:

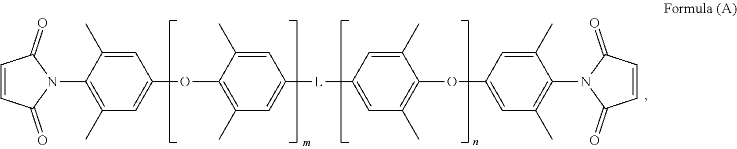

in Formula (A), L represents a divalent organic group derived from a phenol-based compound,
m represents an integer from 0 to 20, and
n represents an integer from 0 to 20.

Based on the above, the invention provides a polyphenylene ether bismaleimide resin with a rigid structure, which has good dielectric properties and heat resistance.

To make the features and advantages of the disclosure to be comprehended more easily, embodiments are described in detail as follows.

### DESCRIPTION OF THE EMBODIMENTS

The following are embodiments describing the content of the invention in detail. The implementation details provided in the embodiments are for illustrative purposes, and are not intended to limit the scope of protection of the content of the invention. Those with ordinary knowledge in the art may modify or change these implementation details according to the needs of the actual implementation.

The “divalent organic group” as used in the specification is an organic group having two bonding positions. And the “divalent organic group” may form two chemical bonds through these two bonding positions.

The invention provides a polyphenylene ether bismaleimide resin formed from a modified polyphenylene ether diamine and a maleic anhydride by a condensation polymerization, wherein the modified polyphenylene ether diamine is formed by reacting a phenol-based compound with a polyphenylene ether.

Thus, the polyphenylene ether bismaleimide resin of the invention has a steric structure, which makes the polyphenylene ether bismaleimide resin have good dielectric properties and heat resistance.

Next, the modified polyphenylene ether diamine is described in detail as follows.

### Modified Polyphenylene Ether Diamine

The modified polyphenylene ether diamine is formed by reacting a phenol-based compound with a polyphenylene ether.

### Phenol-Based Compound

The phenol-based compound may include two or more phenolic groups. The phenol-based compound may include any one of compounds represented by Formula (1) to Formula (9) as follows or other suitable phenol-based compound. In this embodiment, the phenol-based compound preferably includes any one of compounds represented by Formula (1) to Formula (3). The phenol-based compound may be used alone or in combination.

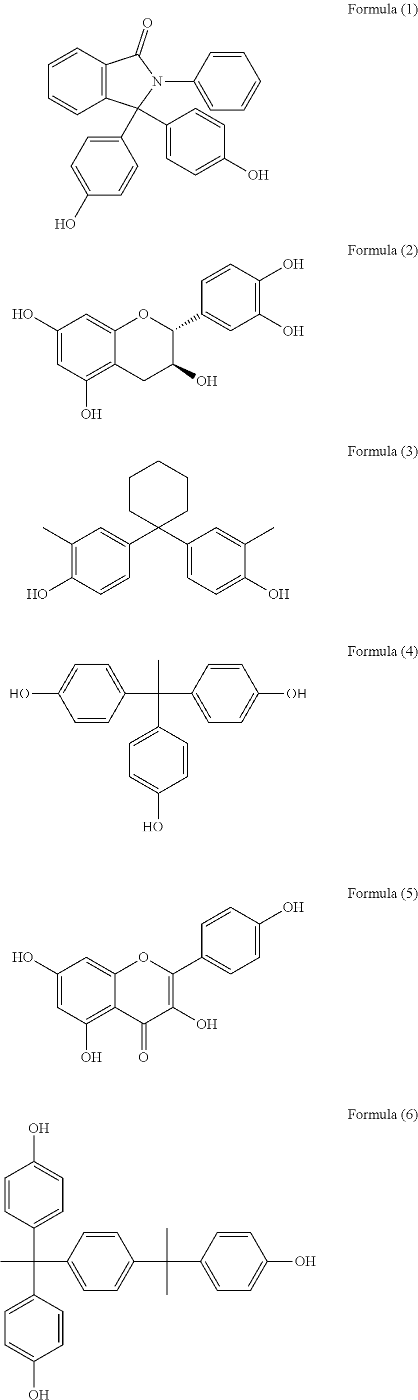 [SMILES: O=C1c2ccccc2C(c2ccc(O)cc2)(c2ccc(O)cc2)N1c1ccccc1 ; Oc1cc(O)c2c(c1)O[C@H](c1ccc(O)c(O)c1)[C@@H](O)C2 ; Cc1cc(C2(c3ccc(O)c(C)c3)CCCCC2)ccc1O ; CC(c1ccc(O)cc1)(c1ccc(O)cc1)c1ccc(O)cc1 ; O=c1c(O)c(-c2ccc(O)cc2)oc2cc(O)cc(O)c12 ; CC(C)(c1ccc(O)cc1)c1ccc(C(C)(c2ccc(O)cc2)c2ccc(O)cc2)cc1]

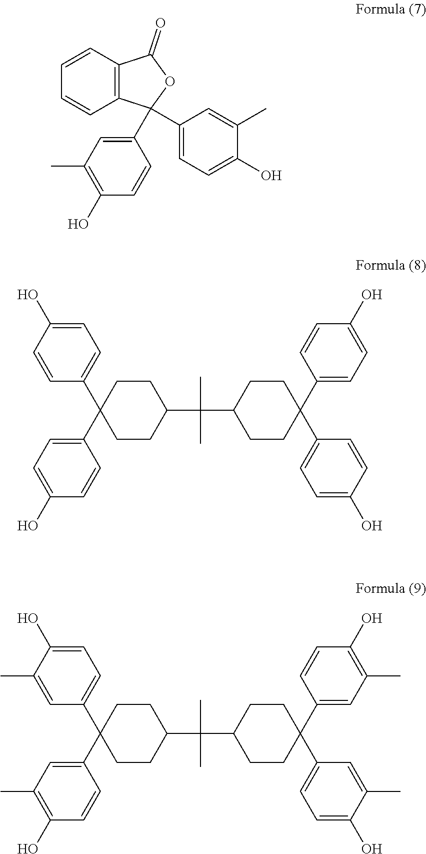

### Polyphenylene Ether

Specific examples of commercially available products of polyphenylene ether include NORYL SA90 (trade name; manufactured by Saudi Basic Industries Corporation (SABIC); weight average molecular weight: 1,600), NORYL SA9000 (trade name; manufactured by Saudi Basic Industries Corporation; weight average molecular weight: 2,300), or a combination thereof.

In this embodiment, the phenol-based compound is first reacted with the polyphenylene ether, and then a group at the end of the modified polyphenylene ether is performed a nitration reaction and a hydrogenation reaction with a compound having a nitro structure (such as 4-halonitrobenzene) to form a modified polyphenylene ether diamine. A ratio of a mole number of the phenol-based compound to a mole number of the polyphenylene ether is 1:1 to 10:1, preferably 2:1 to 5:1.

### <Preparation Method of Polyphenylene Ether Bismaleimide Resin>

First, the modified polyphenylene ether diamine is formed by reacting the phenol-based compound with the polyphenylene. The method of reacting the phenol-based compound with the polyphenylene is not particularly limited, for example, it may be synthesized by well-known organic synthesis methods, which will not be described in detail here. Next, the modified polyphenylene ether diamine and the maleic anhydride are performed to a condensation polymerization to form a polyphenylene ether bismaleimide resin. In this embodiment, a ratio of a mole number of the modified polyphenylene ether diamine to a mole number of the maleic anhydride is 1:1.1 to 1:1.6, preferably 1:1.2 to 1:1.4.

The polyphenylene ether bismaleimide resin has a structure represented by Formula (A) as follows. In this embodiment, a weight average molecular weight of the polyphenylene ether bismaleimide resin is 1,000 to 8,000, preferably 1,000 to 4,000.

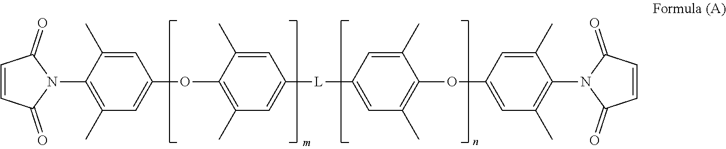

In Formula (A), L represents a divalent organic group derived from a phenol-based compound;
m represents an integer from 0 to 20, preferably an integer from 1 to 10; and
n represents an integer from 0 to 20, preferably an integer from 1 to 10.

In this embodiment, the divalent organic group represented by L may be derived from the phenol-based compound including two or more phenolic groups. The phenol-based compound may include any one of compounds represented by Formula (1) to Formula (9) above, preferably any one of compounds represented by Formula (1) to Formula (3).

### Examples of Polyphenylene Ether Bismaleimide Resin

Example 1 to Example 3 and Comparative example 1 of the polyphenylene ether bismaleimide resin are described below:

### Example 1

3.5 parts by weight of the compound represented by Formula (1), 0.45 parts by weight of triphenyl phosphine (TPP) as a catalyst and 1 part by weight of the polyphenylene ether (trade name: NORYL SA90, manufactured by SABIC) were added in 1.5 mol of toluene as a reaction solvent, and reacted at a temperature of 145° C. for 120 minutes to form a modified polyphenylene ether. Next, 1.3 mol of 4-fluoronitrobenzene was added thereto, and reacted at a temperature of 140° C. for 120 minutes to perform a nitration reaction. Then, hydrogen gas was inserted thereto, and reacted at a temperature of 100° C. for 120 minutes to perform a hydrogenation reaction to form a modified polyphenylene ether diamine. Next, 1.38 mol of maleic anhydride was added thereto, and reacted at a temperature of 110° C. for 180 minutes. After 2 mol of methylbenzenesulfonic acid as a dehydration agent was added thereto, the polyphenylene ether bismaleimide resin of Example 1 was obtained.

### Example 2 to Example 3 and Comparative Example 1

The polyphenylene ether bismaleimide resin of Example 2 to Example 3 and Comparative example 1 were prepared using the same steps as Example 1, and the difference thereof is: the type of the phenol-based compound of the polyphenylene ether bismaleimide resins were changed (as shown in Table 1). The obtained polyphenylene ether bismaleimide resins were evaluated by each of the following evaluation methods, and the results thereof are as shown in Table 1.

TABLE 1

| | | | | Comparative |
|---|---|---|---|---|
| | Example 1 | Example 2 | Example 3 | example 1 |
| Phenol-based | Compound | Compound | Compound | Compound |
| compound | represented by | represented by | represented by | represented by |
| | Formula (1) | Formula (2) | Formula (3) | Formula (10) |
| Weight average | 2,778 | 2,795 | 2,643 | 2,000 |
| molecular weight (Mw) | | | | |
| Tg (unit: ° C.) | 248 | 241 | 245 | 203 |
| CTE (unit: ppm/° C.) | 40 | 43 | 42 | 49 |
| Dielectric constant | 2.47 | 2.48 | 2.50 | 2.42 |
| (Dk) | | | | |
| Dissipation factor (Df) | 0.0020 | 0.0020 | 0.0024 | 0.0017 |

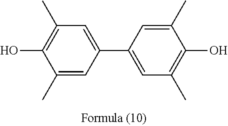 [SMILES: Cc1cc(-c2cc(C)c(O)c(C)c2)cc(C)c1O]

### <Evaluation Methods>

a. Weight Average Molecular Weight (Mw)

The prepared polyphenylene ether bismaleimide resin was measured for a weight average molecular weight via a gel permeation chromatograph (GPC). And tetrahydrofuran (THF) was used as a calibration standard.

b. Glass Transition Temperature (Tg)

The prepared polyphenylene ether bismaleimide resin was measured for a glass transition temperature (Tg) via a differential scanning calorimeter (DSC). When the Tg is greater, the polyphenylene ether bismaleimide resin has good resistance to phase changes, that is, good heat resistance.
Heating rate: 10° C./min
Temperature range: 0° C. to 350° C. (heating, cooling, heating)
   c. Coefficient of Thermal Expansion (CTE)

The prepared polyphenylene ether bismaleimide resin was measured for coefficient of thermal expansion (CTE) via a Thermal Mechanical Analyzer (Model: TMA Q400, manufactured by TA Instruments). When the CTE is smaller, the polyphenylene ether bismaleimide resin has good resistance to phase changes, that is, good heat resistance.
Heating rate: 10° C./min
Temperature range: 0° C. to 300° C.
   d. Dielectric Constant (Dk)

The prepared polyphenylene ether bismaleimide resin was coated on a substrate, and baked at a temperature of 210° C. for 60 minutes to form a sheet with thickness of 0.25 mm. Next, the sheet was measured for a dielectric constant (Dk) at a frequency of 1 GHz via a resonant cavity. When the dielectric constant is smaller, the polyphenylene ether bismaleimide resin has good dielectric property.

e. Dissipation Factor (Df)

The prepared polyphenylene ether bismaleimide resin was coated on a substrate, and baked at a temperature of 210° C. for 60 minutes to form a sheet with thickness of 0.25 mm. Next, the sheet was measured for a dissipation factor (Df) at a frequency of 1 GHz via a resonant cavity. When the dissipation factor is smaller, the polyphenylene ether bismaleimide resin has good dielectric property.

### <Evaluation Results>

It may be seen from Table 1 that when the polyphenylene ether bismaleimide resins have a steric structure (Examples 1 to 3), the polyphenylene ether bismaleimide resins have both good heat resistance and dielectric properties at the same time.

In addition, compared to the polyphenylene ether bismaleimide resin (Comparative example 1) which does not have a steric structure derived from the phenol-based compound, the polyphenylene ether bismaleimide resins (Examples 1 to 3) which have a steric structure derived from the phenol-based compound have greater glass transition temperature and smaller coefficient of thermal expansion, that is, better heat resistance, and have good dielectric properties at the same time.

Based on the above, the polyphenylene ether bismaleimide resin of the invention has a steric structure, so it has good dielectric properties and heat resistance. Therefore, the polyphenylene ether bismaleimide resin has good applicability.

Although the invention has been disclosed in the embodiments above, they are not intended to limit the invention. Anyone with ordinary knowledge in the relevant technical field can make changes and modifications without departing from the spirit and scope of the invention. The scope of protection of the invention shall be subject to those defined by the claims attached.

What is claimed is:

1. A polyphenylene ether bismaleimide resin, formed from a modified polyphenylene ether diamine and a maleic anhydride by a condensation polymerization,
wherein the modified polyphenylene ether diamine is formed by reacting a phenol-based compound with a polyphenylene ether.

2. The polyphenylene ether bismaleimide resin according to claim 1, wherein a ratio of a mole number of the modified polyphenylene ether diamine to a mole number of the maleic anhydride is 1:1.1 to 1:1.6.

3. The polyphenylene ether bismaleimide resin according to claim 1, wherein a ratio of a mole number of the phenol-based compound to a mole number of the polyphenylene ether is 1:1 to 10:1.

4. The polyphenylene ether bismaleimide resin according to claim 1, a weight average molecular weight thereof is 1,000 to 8,000.

5. The polyphenylene ether bismaleimide resin according to claim 1, wherein the phenol-based compound includes two or more phenolic groups.

6. The polyphenylene ether bismaleimide resin according to claim 1, wherein the phenol-based compound includes any one of compounds represented by Formula (1) to Formula (9) as follows:

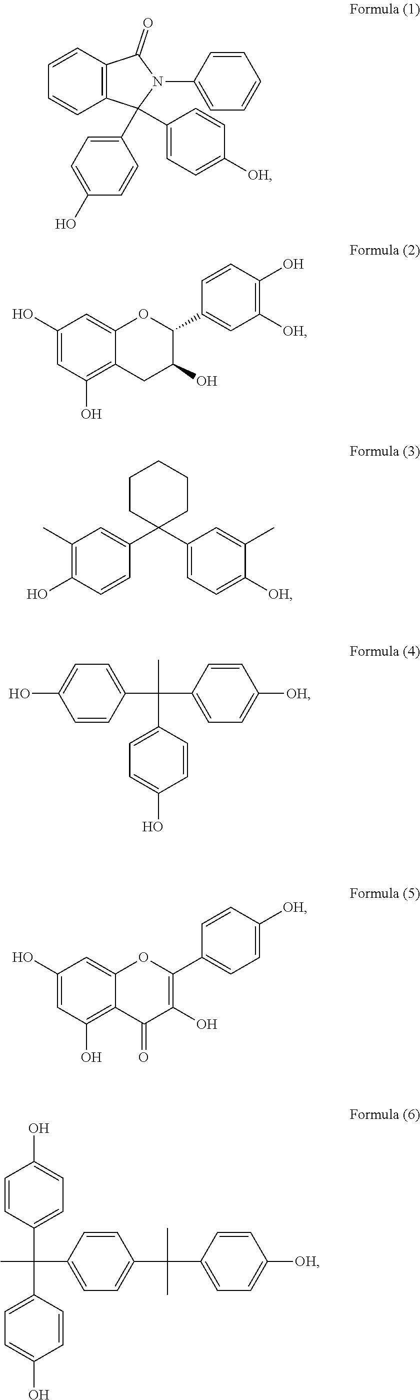 [SMILES: O=C1c2ccccc2C(c2ccc(O)cc2)(c2ccc(O)cc2)N1c1ccccc1 ; Oc1cc(O)c2c(c1)O[C@H](c1ccc(O)c(O)c1)[C@@H](O)C2 ; Cc1cc(C2(c3ccc(O)c(C)c3)CCCCC2)ccc1O ; CC(c1ccc(O)cc1)(c1ccc(O)cc1)c1ccc(O)cc1 ; O=c1c(O)c(-c2ccc(O)cc2)oc2cc(O)cc(O)c12 ; CC(C)(c1ccc(O)cc1)c1ccc(C(C)(c2ccc(O)cc2)c2ccc(O)cc2)cc1]

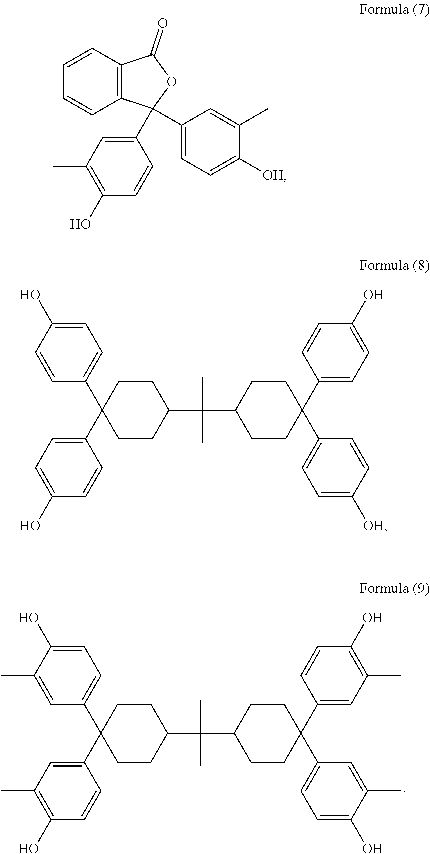

7. A polyphenylene ether bismaleimide resin, having a structure represented by Formula (A) as follows: 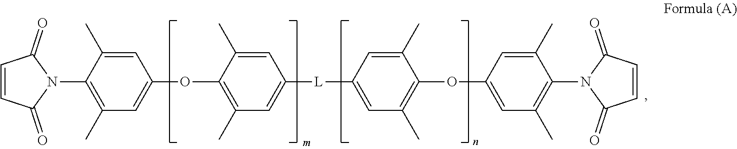
in Formula (A), L represents a divalent organic group derived from a phenol-based compound,
m represents an integer from 0 to 20, and
n represents an integer from 0 to 20.

8. The polyphenylene ether bismaleimide resin according to claim 7, wherein the phenol-based compound includes two or more phenolic groups.

9. The polyphenylene ether bismaleimide resin according to claim 7, wherein the phenol-based compound includes any one of compounds represented by Formula (1) to Formula (9) as follows:

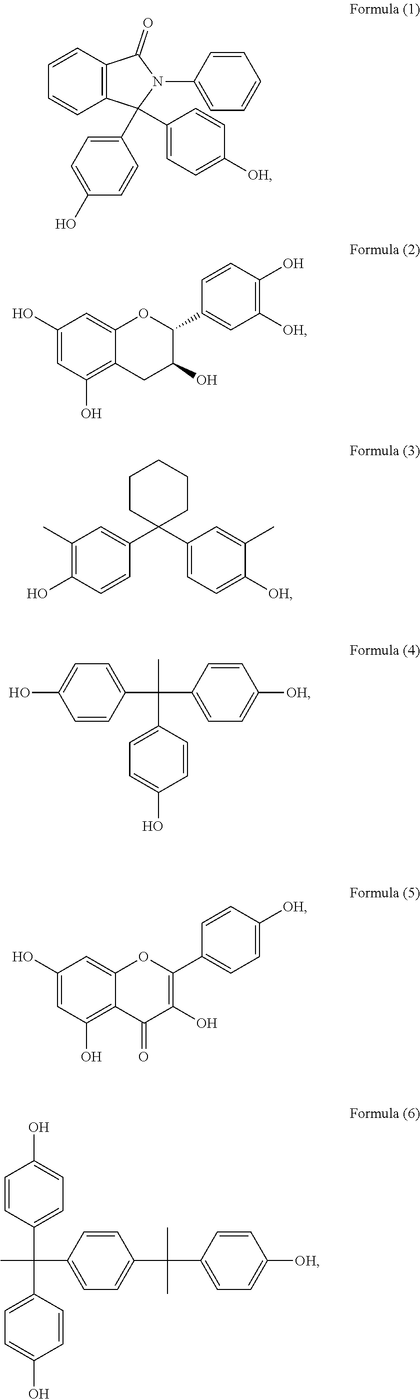 [SMILES: O=C1c2ccccc2C(c2ccc(O)cc2)(c2ccc(O)cc2)N1c1ccccc1 ; Oc1cc(O)c2c(c1)O[C@H](c1ccc(O)c(O)c1)[C@@H](O)C2 ; Cc1cc(C2(c3ccc(O)c(C)c3)CCCCC2)ccc1O ; CC(c1ccc(O)cc1)(c1ccc(O)cc1)c1ccc(O)cc1 ; O=c1c(O)c(-c2ccc(O)cc2)oc2cc(O)cc(O)c12 ; CC(C)(c1ccc(O)cc1)c1ccc(C(C)(c2ccc(O)cc2)c2ccc(O)cc2)cc1]

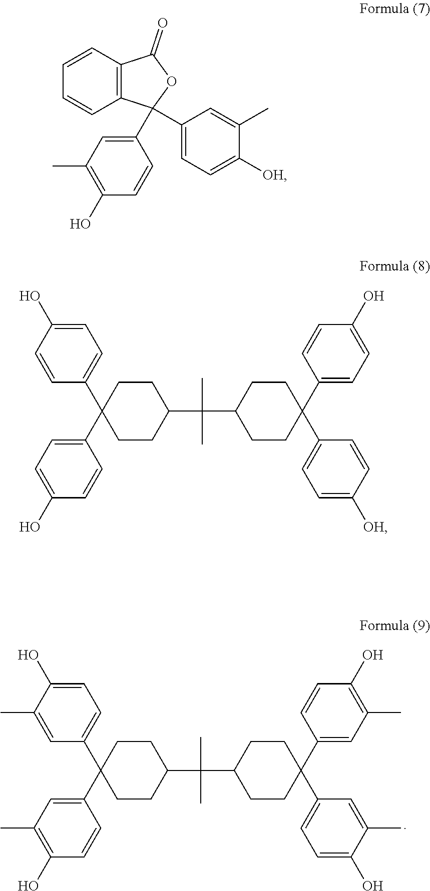

10. The polyphenylene ether bismaleimide resin according to claim 7, a weight average molecular weight thereof is 1,000 to 8,000.
